(19) United States
(12) Patent Application Publication
(10) Pub. No.: US 2026/0316937 A1
(43) Pub. Date: Oct. 15, 2026

(54) INDUCTION CHARGING HOUSING FOR A SEAT, PROVIDED WITH A LATERAL RETAINING DEVICE

(71) Applicant: Safran Seats, Plaisir (FR)

(72) Inventors: Yann Cavereau, Moissy-Cramayel (FR); Oscar Ruiz, Moissy-Cramayel (FR); Arthur K. Glain, Moissy-Cramayel (FR)

(21) Appl. No.: 19/101,377

(22) PCT Filed: Jul. 26, 2023
(86) PCT No.: PCT/EP2023/070771

§ 371 Date: Feb. 5, 2025

(30) Foreign Application Priority Data
Aug. 31, 2022 (FR) 2208704

(51) Int. Cl. B64D 11/06; B60R 7/04; B60R 11/00; B60R 11/02; B60R 16/037; H02J 50/10

(52) U.S. Cl. CPC B64D 11/0636; B60R 7/043; B60R 11/02; B60R 16/037; H02J 50/10; B60R 2011/0015; B60R 2011/0059; B60R 2011/0276

(57) ABSTRACT

The invention relates to a seat unit for a transport vehicle, comprising:
a seat comprising a seat-base and a backrest, and
an induction charging housing for a portable electronic device having a vertical orientation,
an induction charger capable of generating a magnetic field inside the induction charging housing,
a retaining device being configured to bear against at least one edge of the portable electronic device so that said portable electronic device is held pressed against the back wall of the induction charging housing.

The present invention relates to an induction charging housing for a seat provided with a lateral retaining device. The invention finds a particularly advantageous, but not exclusive, application with seat units of “business class and “first class” type in an aircraft cabin.

In a manner known per se, such a seat unit comprises a seat and a side console provided with storage equipments along one side of the seat. In addition, a shell extends at least partly around the seat so as to delimit a space around the passenger. Such a configuration allows to guarantee the privacy of the passenger.

The seat offers the passenger different comfort positions, from a “sitting” position to a “lying” position, in which the seat defines a substantially horizontal sleeping surface so that the passenger can lie down. Intermediate comfort positions are also provided, such as the “relax” position in which a seat back is strongly inclined. Generally, these intermediate positions are obtained by tilting the pivoting back about a horizontal axis and perpendicular to an extension axis of the seat. The passenger can remain on the seat during transitions between the different positions. The seat generally consists in particular of the back and a seating pan and is likely to include a leg rest and/or a foot rest, which may be fixed or linked to a kinematics of the seat.

Inductive charging of portable electronic appliances, typically mobile phones, is increasingly requested by airlines for business class aircraft seats. The induction charger is generally integrated in a horizontal upper face of the console forming a table on which the passenger can place personal objects, drinks, a meal tray, or any type of object that the passenger would like to have available nearby during the trip. However, such a configuration of the induction charger does not guarantee the necessary immobility of the mobile phone so as to ensure its charging. In addition, it takes up an upper space on the console that could be used more wisely and does not automatically offer a direct view of the progress of the phone's charge from the passenger seat.

The objective of the invention is to effectively remedy these drawbacks by providing a seat unit for a transport vehicle comprising
a seat including a seating pan and a backrest,
an induction charging housing for a portable electronic appliance having a vertical orientation,
said induction charging housing comprising a lower face for a lower face of the portable electronic appliance to bear thereon, an upper face, a right side face, a left side face, and a housing bottom,
an induction charger capable of generating a magnetic field inside the induction charging housing,
a retaining device being configured so that it can bear against at least one edge of the portable electronic appliance in order that said portable electronic appliance is pressed against the bottom of the induction charging housing.

The invention thus permits, thanks to the integration of an induction charging housing in a vertical orientation, to save space at the table surface of the console. The use of the retaining device allows to guarantee the induction charging of the portable electronic appliance when the latter has a vertical orientation. In addition, such an arrangement of the charging housing allows the passenger to permanently keep an eye on the portable electronic appliance, in particular so as to observe the evolution of the battery charge level. The invention makes it possible for the passenger to have access to the screen of the portable electronic appliance in order to unlock it and, if need be, use it during the loading phase of the battery.

According to one embodiment of the invention, the retaining device is mounted so as to slide vertically from the upper face of the induction charging housing so as to bear against an upper edge of the portable electronic appliance.

According to one embodiment of the invention, the retaining device has a rear face coming into contact with the upper edge of the portable electronic appliance while forming a non-zero angle relative to a vertical plane.

According to one embodiment of the invention, the retaining device is movable in rotation around a spring hinge along a vertical axis.

According to one embodiment of the invention, the retaining device comprises an elongated plate extending vertically along a lateral strip of the induction charging housing.

According to one embodiment of the invention, the retaining device is movable in rotation around a spring hinge having a horizontal axis.

According to one embodiment of the invention, the spring hinge is positioned above or at the top face of the induction charging housing.

According to one embodiment of the invention, the retaining device comprises a first lateral holding element extending longitudinally along the left lateral face of the induction charging housing and a second lateral holding element extending longitudinally along the right lateral face of the induction charging housing, said first lateral holding element bearing against a left edge of the portable electronic appliance, said second lateral holding element bearing against a right edge of the portable electronic appliance.

According to one embodiment of the invention, the first lateral holding element and the second lateral holding element are each movable in translation in a horizontal direction.

According to one embodiment of the invention, a first elastic member biases the first lateral holding element towards a center of the induction charging housing and a second elastic member biases the second lateral holding element towards the center of the induction charging housing.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

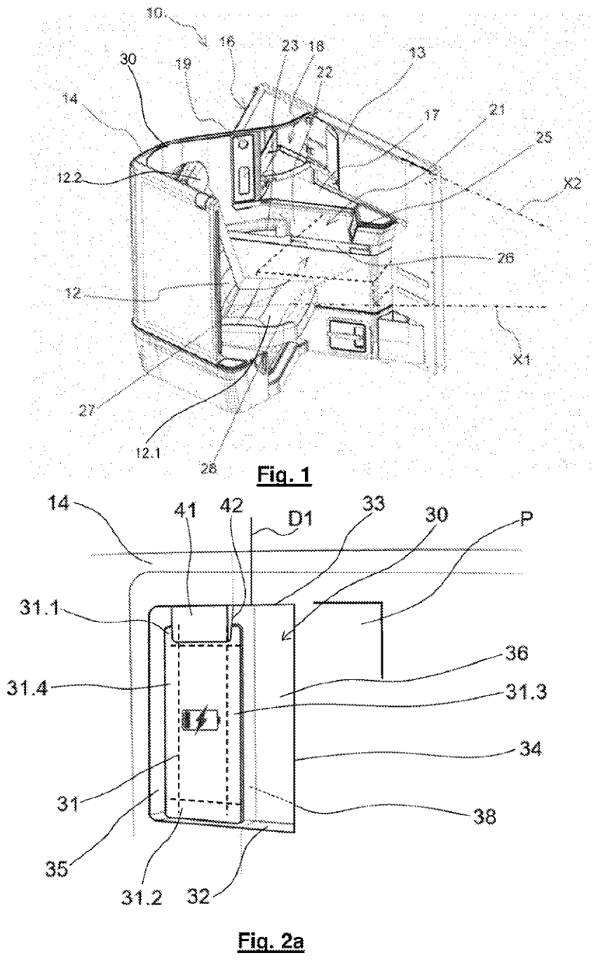

FIG. 1 is a perspective view of a seat unit comprising an induction charging housing according to the present invention;

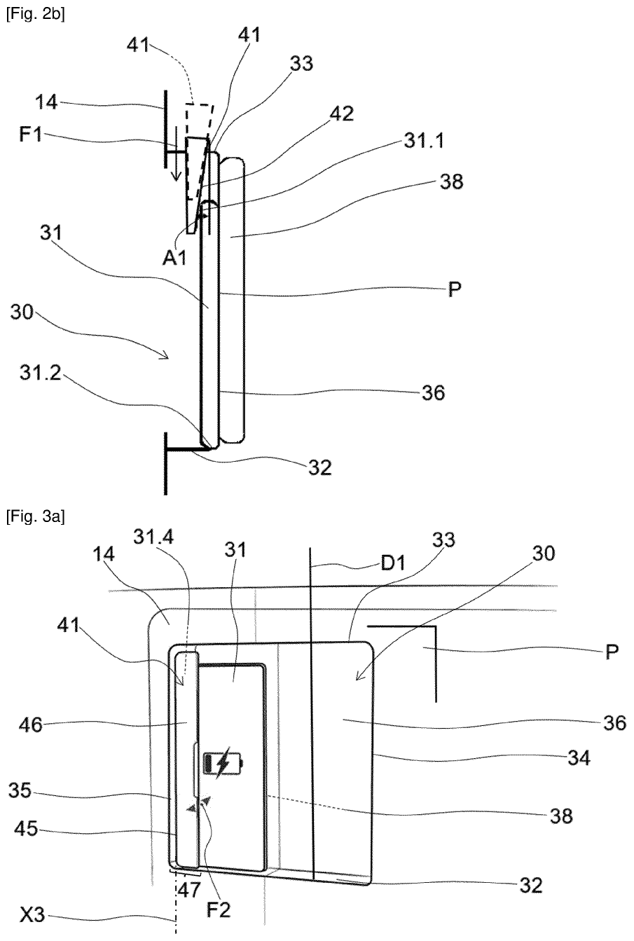

FIGS. 2a and 2b are respectively perspective and side views of a first embodiment of a device according to the invention for retaining a portable electronic appliance inside an induction charging housing;

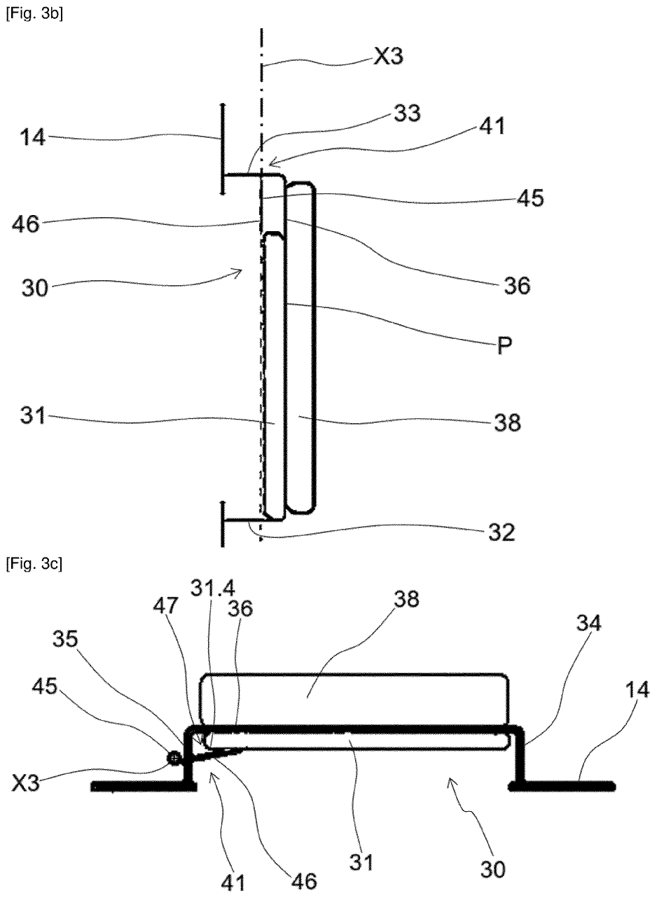

FIGS. 3a, 3b, and 3c are respectively perspective, side, and top views of a second embodiment of a device according to the invention for retaining a portable electronic appliance inside an induction charging housing;

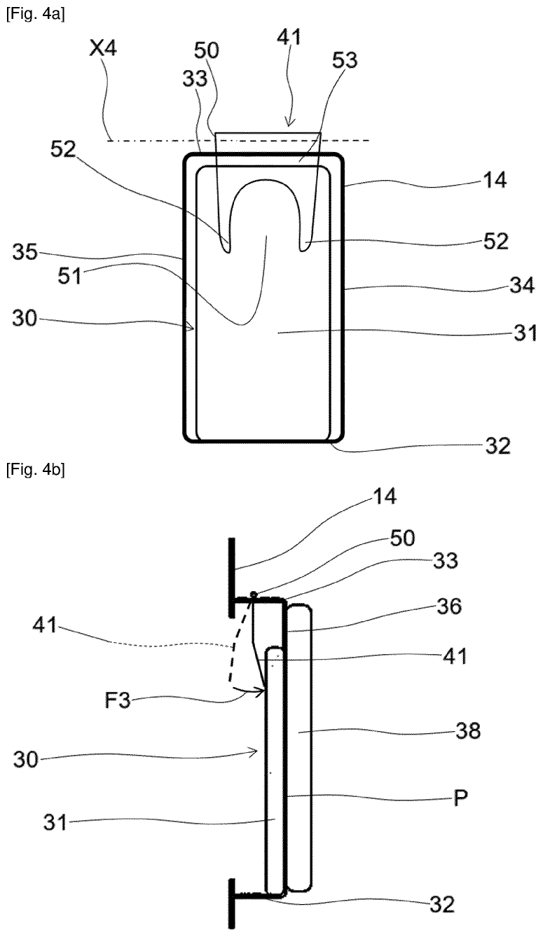

FIGS. 4a and 4b are front and side views, respectively, of a third embodiment of the induction charging housing according to the present invention;

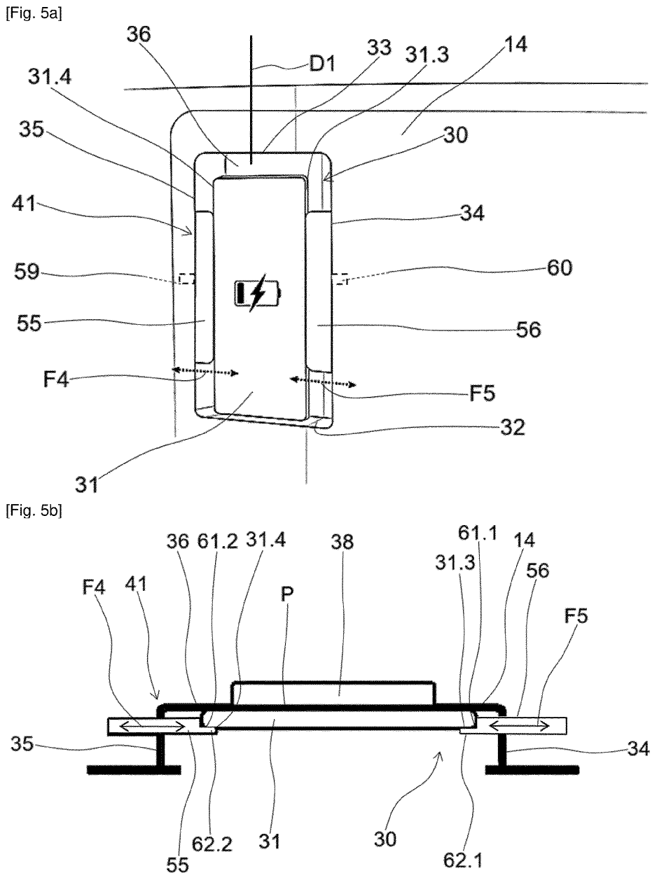

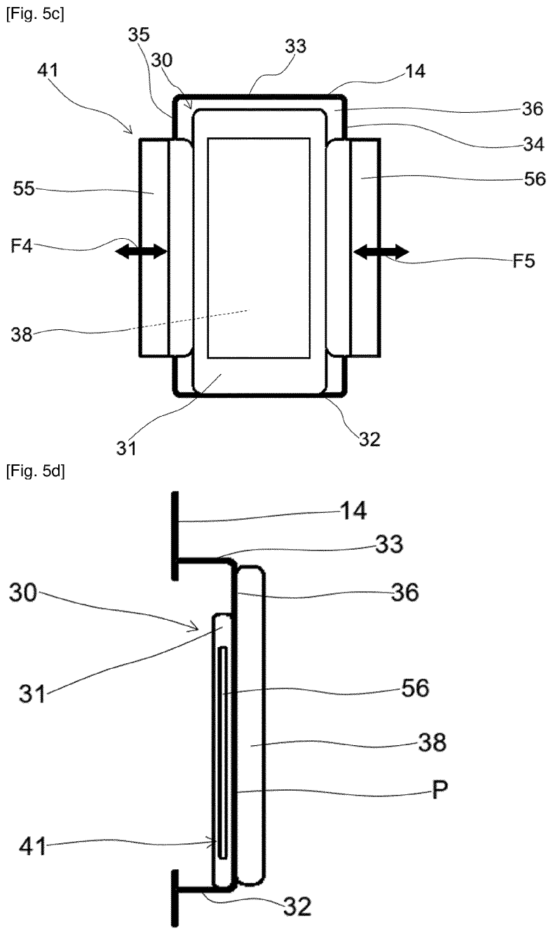

FIGS. 5a, 5b, 5c and 5d are respectively front and side views of a third embodiment of the induction charging housing according to the present invention.

It should be noted that the structural and/or functional elements common to the different embodiments have the same references. Thus, unless otherwise stated, such elements have identical structural, dimensional and material properties.

Furthermore, in the remainder of the description, the relative terms of the type “lower”, “upper”, “left”, “right”, “horizontal”, “vertical” are understood by reference to the common meaning that a passenger in a seat in front of which there is an induction charging according to the invention would give them.

FIG. 1 shows a seat unit 10 having a seat 12 associated with a side console 13 extending along one side of the seat 12.

More specifically, the seat 12 comprises a seating pan 12.1 and a backrest 12.2. The seat 12 has an extension axis X1 defined by the intersection between a horizontal plane and a vertical median plane of the seat 12 corresponding to a plane of symmetry of the seat 12. The extension axis X1 of the seat 12 may form a non-zero angle with respect to a direction parallel to or coincident with a central axis of the aircraft X2. In this case, the seat 12 is oriented in the direction of the axis X2. Alternatively, the seat 12 may be oriented in a direction opposite to the axis X2. Alternatively, the axis X1 of the seat extends parallel to the central axis of the aircraft X2.

The seat 12 is advantageously provided with a kinematics allowing it to be movable between a “seating” position, in which the seat 12 is configured to define a seating position of a passenger, and a “reclined” position, in which the seating pan 12.1 and the backrest 12.2 define a sleeping surface, advantageously substantially horizontal, for the passenger. Intermediate comfort positions are also offered, such as the “relax” position in which a backrest of the seat 12 is strongly inclined.

A privacy shell 14 extends at least partially around the seat 12 so as to delimit a space around the passenger. The privacy shell 14 is made for example from a composite material. Such a configuration allows to guarantee the privacy of the passenger in the seat 12.

A video screen 16 of a multimedia system or IFE (for “Inflight Entertainment System”) can be installed on a rear portion of the privacy shell 14 so as to be usable by a rear passenger.

The console 13 may comprise an upper wall 17 forming a table on which the passenger can place objects as well as a storage space 18 comprising one or more elements among a literature pocket, a bottle holder, or a minibar. The choice of storage equipments is configurable according to the wishes of the airline. The console 13 may also include a reading light 19 towards the seat 12.

A cavity 21 is located under the upper wall 17. The cavity 21 is laterally open towards the seat 12. In addition, a horizontal face 22 of the console 13 has in particular an armrest function. For this purpose, the horizontal face 22 may locally have a curved cuff shape 23 matching the shape of a portion of the passenger's arm.

The console 13 also includes a control unit 25 for the seat 12 and its additional components (called “PCU” for “Passenger Control Unit”). The control unit 25 allows the passenger in particular to control the selection of a position of the seat 12 as well as the additional components, such as a video system, a heating device, a lighting ambiance system or any other additional component that can be integrated into the seat 12.

In order to allow the passenger to lie down, the console 13 may include a hollow space 27 in a phantom view in FIG. 1 in which an ottoman 28 is arranged. The ottoman 28 includes a horizontal face forming a footrest on which a rear passenger can place his feet when the seat 12 is in the “lying” position.

The seat unit 10 may also conventionally comprise a meal tray 26 movable between a stored position (corresponding to that in FIG. 1) in which the meal tray 26 is located inside a housing in the console 13 and a deployed position in which the meal tray 26 is outside the housing so as to allow the passenger to place a meal tray thereon.

As can be seen in FIGS. a and 2b, the seat unit 10 further comprises an induction charging housing 30 for a portable electronic appliance 31.

The portable electronic appliance 31 comprises an upper edge 31.1, a lower edge 31.2, a right edge 31.3, and a left edge 31.4. Each edge 31.1-31.4 extends along a longitudinal strip a few millimeters wide on the front face of the portable electronic appliance 31. The front face of the portable electronic appliance 31 corresponds to the face of the screen of the portable electronic appliance 31. The edges 31.1, 31.2, 31.3, 31.4 are thus edges of a front face of the portable electronic appliance 31.

More specifically, the upper edge 31.1 extends longitudinally horizontally on the upper side of the portable electronic appliance 31 when the latter is inside the induction charging housing 30 and along a width having a dimension less than 30 mm, preferably less than 20 mm. The lower edge 31.2 extends longitudinally horizontally on the lower side of the portable electronic appliance 31 when the latter is inside the induction charging housing 30 and along a width having a dimension less than 30 mm, preferably less than 20 mm. The right edge 31.3 extends longitudinally vertically on the right side of the portable electronic appliance 31 when the latter is inside the induction charging housing 30 and along a width having a dimension less than 30 mm, preferably less than 20 mm. The left edge 31.4 extends longitudinally vertically on the left side of the portable electronic appliance 31 when the latter is inside the induction charging housing 30 and along a width having a dimension less than 30 mm, preferably less than 20 mm. A retaining device 41 described in more detail below may bear against all or part of a corresponding edge.

The portable electronic appliance 31 may take the form of a mobile phone, a digital tablet, or a laptop computer. In the remainder of the description, reference is made to a mobile phone as an example but it is clear that this mobile phone could be replaced with any other portable electronic appliance capable of being recharged by induction.

The induction charging housing 30 is located at the rear of the backrest 12.2. In this case, the induction charging housing 30 is made in the rear face of the privacy shell 14. Alternatively, the induction charging housing 30 may be made in the rear face of the backrest 12.2.

The induction charging housing 30 comprises a lower face 32 for an edge of the mobile phone 31 to bear thereon, an upper face 33, a right side face 34, a left side face 35, and a housing bottom 36. The bottom 36 is set back from the rear face of the privacy shell 14 or, if need be, of the backrest 12.2. The faces 32, 33, 34, 35 extend perpendicularly to the bottom 36.

The induction charging housing 30 has a vertical orientation, such that the bottom 36 of the induction charging housing 30 extends in a vertical plane P. The induction charging housing 30 is thus open to the outside in a horizontal direction. Advantageously, the induction charging housing 30 has a longitudinal elongation direction D1 extending in a vertical direction. Alternatively, the longitudinal elongation direction D1 can extend in a horizontal direction.

An induction charger 38 is capable of generating a magnetic field inside the induction charging housing 30. The action of this magnetic field causes the appearance of a charging current for a battery inside the mobile phone 31 provided with a coil for this purpose. The induction charger 38 is advantageously arranged behind the bottom 36 of the induction charging housing 30. Alternatively, the induction charger 38 constitutes at least a portion, or even the entirety, of the bottom 36. Thus, when the mobile phone 31 is pressed against the bottom 36 of the housing 30, the recharging of the battery in the mobile phone 31 can be carried out without contact via the induction charger 38.

A retaining device 41 is configured to come into contact with at least one edge of the mobile phone 31, such that said mobile phone 31 is pressed against the bottom 36 of the induction charging housing 30 behind which the induction charger 38 is arranged.

In the embodiment in FIGS. 2a and 2b, the retaining device 41 is mounted so as to slide vertically from the upper face 33 of the induction charging housing 30 so as to bear against the upper edge 31.1 of the mobile telephone 31. The retaining device 41 is capable of sliding into an opening made inside the upper face 33 of the induction charging housing 30.

The retaining device 41 has a rear face 42 for contacting the upper edge 31.1 of the mobile telephone 31 while forming a non-zero angle A1 relative to a vertical plane. The angle A1 is for example of the order of 5 degrees. The retaining device 41 may have the shape of a beveled wedge having a trapezoidal or triangular section.

The retaining device 41 is movable between an open position shown in dotted lines in which said retaining device 41 is released from the mobile phone 31 and a closed position in which the retaining device 41 bears against the upper edge 31.1 of the mobile phone 31 so as to press said mobile phone 31 against the bottom 36 of the induction charging housing 30.

In the open position, a length of the retaining device 41 extending inside the induction charging housing 30 is between 15 mm and 25 mm and is preferably of the order of 20 mm. In the closed position, the retaining device 41 may have a length deployed inside the induction charging housing 30 measured from the face 33 of between 40 mm and 60 mm and preferably up to 50 mm.

The position adjustment of the retaining device 41 in the vertical direction may be carried out by gravity and friction. Alternatively, it is possible to integrate a spring biasing the retaining device 41 against the upper edge 31.1 of the mobile phone 31. The inclined rear face 42 and the vertical sliding allow the retaining device 41 to easily adapt to variations in height and thickness of the mobile phone 31 depending on the models.

In order to install her/his mobile phone 31 inside the charging housing, the passenger pulls the retaining device 41 upwards so as to move it into the open position and thus clear access to the bottom 36 of the housing 30. The passenger can then position her/his mobile phone 31 inside the induction charging housing 30. By releasing the retaining device 41, the wedge of the retaining device 41 descends according to the arrow F1 by gravity or by the action of the return spring so as to bear against the upper edge 31.1 of the mobile phone 31. This has the effect of keeping the mobile phone 31 pressed against the bottom 36 of the induction charging housing 30 and therefore against the induction charger 38.

In the embodiment in FIGS. 3a, 3b and 3c, the retaining device 41 is rotatable relative to the bottom 36 around a spring hinge 45 along a vertical axis X3. The rotation of the retaining device 41 is illustrated by the arrow F2 in FIG. 3a.

The retaining device 41 comprises an elongated plate 46 extending vertically along a lateral strip 47 of the induction charging housing 30. In this case, the retaining device 41 occupies a lateral strip 47 on the left side of the induction charging housing 30. The lateral strip 47 extends longitudinally in a vertical direction and along a width of a few millimeters, in particular less than 30 mm. Alternatively, the lateral strip can be on the right side of the induction charging housing 30. The spring hinge 45 may be set inwards an internal volume delimited by the privacy shell 14 relative to the right lateral face 34 or the left lateral face 35 in which the retaining device 41 is integrated.

The elongated plate 46 preferably has a width of between 10 mm and 25 mm and is preferably of the order of 20 mm in width. The retaining device 41 preferably extends vertically along an entire height of the induction charging housing 30. Alternatively, the retaining device 41 retention 41 may extend along a portion of the height of the accommodation only.

The retaining device 41 is movable between an open position in which the elongated bar 46 is distant from the bottom 36 of the induction charging housing 30 so as to allow the insertion of the mobile phone 31 into the space between the elongated the elongated bar 46 and the bottom 36 of the induction charging housing 30 and a closed position in which the retaining device 41 bears against the left edge 31.4 (alternatively the right edge 31.3) of the mobile phone 31 so as to press said mobile phone 31 against the bottom 36 of the induction charging housing 30.

In the open position, the retaining device 41 is located at a distance of the order of 10 mm from the bottom 36 of the induction charging housing 30 so as to allow an easy installation of the mobile phone 31. In the closed position, the minimum distance between the elongated bar 46 and the bottom 36 of the induction charging housing 30 is 5 mm so as to be able to adapt to all thicknesses of mobile phones. This retaining device 41 only occupies the side strip 47 of the mobile phone 31, which allows the use of the mobile phone 31 when the latter is in a charging phase.

In order to install her/his mobile phone 31 inside the induction charging housing 30, the passenger pulls the retaining device 41 towards her/him, so as to pivot it around the spring hinge 45 in order to move the elongated plate 46 away from the bottom 36 and thus the retaining device 41 into the open position. The passenger can then position her/his mobile phone 31 between the bottom 36 of the induction charging housing 30 and the elongated plate 46. By releasing the retaining device 41, the elongated plate 46 automatically presses the mobile phone 31 against the bottom 36 of the induction charging housing 30 and therefore against the induction charger 38 due to the action of the spring of the hinge 45.

In the embodiment in FIGS. 4a and 4b, the retaining device 41 is rotatable about a spring hinge 50 having a horizontal axis X4. The spring hinge 50 is positioned above or at the face upper 33 of the induction charging housing 30. The spring hinge 50 is set forwards from the plane P in which the bottom 36 of the induction charging housing 30 extends.

The retaining device 41 may have a plate shape, if necessary curved or folded in a horizontal direction. The retaining device 41 may include a central notch 51 so as to define two branches 52 from a base 53 of generally rectangular shape mechanically linked to the spring hinge 50. Such a configuration permits to minimize the pressing surface corresponding to the hidden surface of the mobile phone 31 by the retaining device 41. Such a configuration thus allows the use of the mobile phone 31 during its charging.

The retaining device 41 is movable between an open position in which the retaining device 41 is distant from the bottom 36 of the induction charging housing 30 so as to allow the insertion of the mobile phone 31 into the space between the branches of the retaining device 41 and the bottom 36 of the induction charging housing 30 and a closed position in which the retaining device 41 bears via the branches 52 against the right edge 31.3 and the left edge 31.4 of the mobile phone 31 in order to press said mobile phone 31 against the bottom 36 of the induction charging housing 30.

In the open position, there is a gap between 10 mm and 30 mm and preferably of the order of 20 mm between the retaining device 41 and the bottom 36 of the induction charging housing 30. In the closed position, the minimum gap between the retaining device 41 and the bottom 36 of the induction charging housing 30 is zero or small, in particular of the order of 2 mm.

This amplitude of movement of the retaining device 41 permits an easy adaptation to variations in the thickness of mobile phones from one model to another. Advantageously, the height of the retaining device 41 measured relative to the upper face 33 of the housing 30 in a vertical direction is between 30 mm and 60 mm and is of the order of 50 mm, which guarantees its adaptation to many types of phones having different heights.

In order to install her/his mobile phone 31 inside the induction charging housing 30, the passenger pulls the retaining device 41 towards her/him, so as to move the retaining device 41 away from the bottom 36 in order to move the retaining device 41 into an open position. The passenger can then position her/his mobile phone 31 between the bottom 36 of the induction charging housing 30 and the retaining device 41. By releasing the retaining device 41, the latter automatically presses the mobile phone 31 against the bottom 36 of the induction charging housing 30 and therefore against the induction charger 38 according to the arrow F3 (see FIG. 4b) due to the action of the spring of the hinge 50.

In the embodiment in FIGS. 5a, 5b, 5c, and 5d, the retaining device 41 comprises a first lateral holding element 55 extending longitudinally along the left lateral face 35 of the induction charging housing 30 and a second lateral holding element 56 extending longitudinally along the right lateral face 34 of the induction charging housing 30. The first lateral holding element 55 bears against the left edge 31.4 of the mobile telephone 31. The second lateral holding element 56 bears against the right edge 31.3 of the mobile telephone 31.

The first lateral holding element 55 and the second lateral holding element 56 are each movable in translation in a horizontal direction (see arrows F4 and F5) which may correspond to a transverse direction relative to the direction D1 of longitudinal elongation of the induction charging housing 30.

A first elastic member 59, such as a spring, biases the first lateral holding element 55 toward a center of the induction charging housing 30 and a second elastic member 60, such as a spring, biases the second lateral holding element 56 toward the center of the induction charging housing 30. The first elastic member 59 bears against the lateral face 35 or is disposed in a cavity in the lateral face 35 of the housing 30. The second elastic member 60 bears against the lateral face 34 or is arranged in a cavity in the lateral face 34 of the housing 30.

As can be seen in FIG. 5b, each lateral holding element 55, 56 comprises a longitudinal portion 62.1, 62.2 capable of ensuring retention of the mobile phone 31. The longitudinal portion 62.1 is intended to come to bear against the right edge 31.3 of the mobile phone 31 and the longitudinal portion 62.2 is intended to come to bear against the left edge of the mobile phone 31. The longitudinal portions 62.1, 62.1 may be obtained by making recesses 61.1, 61.2 depending on the thickness of the holding elements 55, 56. The holding elements 55, 56 have the shape of a plate extending in a plane parallel to the bottom 36 of the housing 30. Each holding element 55, 56 is devoid of a longitudinal portion on the side of the bottom 36 of the housing 30 in order to guarantee contact of the mobile phone 31 against the bottom 36 of the housing 30.

The retaining device 41 is movable between an open position in which the first lateral holding element 55 and the second lateral holding element 56 are distant from each other so as to allow the insertion of the mobile telephone 31 into the space between the lateral holding elements 55, 56; and a closed position in which the first lateral holding element 55 bears against the left edge 31.4 of the mobile phone 31 and the second lateral holding element 56 bears against the right edge 31.3 of the mobile phone 31. The mobile phone 31 is then held tight between the first lateral holding element 55 and the second lateral holding element 56, while being pressed against the bottom 36 of the induction charging housing 30. The springs 59, 60 tend to bias the first lateral holding element 55 and the second lateral holding element 56 towards the closed position.

In the closed position, the minimum gap between the two elements 55, 56 is between 30 mm and 50 mm and is preferably of the order of 40 mm. In the open position, the maximum gap between the two elements 55, 56 is between 80 mm and 120 mm and is preferably of the order of 100 mm.

The first lateral holding element 55 and the second lateral holding element 56 are preferably centered in height relative to the induction charging housing 30. Alternatively, the first lateral holding element 55 and the second lateral holding element 56 each extend along the entire height of the induction charging housing 30.

In order to install her/his mobile phone 31 inside the induction charging housing 30, the passenger moves the first lateral holding element 55 and the second lateral holding element 56 away from each other so as to move the retaining device 41 into an open position. The passenger can then position her/his mobile phone 31 against the bottom 36 of the induction charging housing 30 and the retaining device 41. By releasing the retaining device 41, the first lateral holding element 55 and the second lateral holding element 56 automatically press against the opposite edges 31.3, 31.4 of the mobile phone 31 so as to hold it against the bottom 36 of the induction charging housing 30 and therefore against the induction charger 38.

Of course, the different characteristics, variants and/or embodiments of the present invention can be associated with each other in various combinations insofar as they are not incompatible with or exclusive of one another.

Furthermore, the invention is not limited to the embodiments described above and provided solely by way of example. It encompasses various modifications, alternative forms and other variants which person skilled in the art may envisage in the context of the present invention and in particular any combination of the various operating modes described above may be taken separately or in combination.

1. A seat unit for a transport vehicle comprising:
a seat including a seating pan and a backrest, and
an induction charging housing for a portable electronic appliance, wherein said induction charging housing has a vertical orientation,
said induction charging housing comprising a lower face for a lower face of the portable electronic appliance to bear thereon, an upper face a right side face a left side face, and a housing bottom,
an induction charger capable of generating a magnetic field inside the induction charging housing,
a retaining device being configured to come into contact with at least one edge of the portable electronic appliance so that said portable electronic appliance is kept pressed against the bottom of the induction charging housing,
the retaining device being mounted so as to slide vertically from the upper face of the induction charging housing so as to bear against an upper edge of the portable electronic appliance,
the retaining device being capable of sliding into an opening made inside the upper face of the induction charging housing.

2. The seat unit according to claim 1, wherein the retaining device has a rear face for coming into contact with the upper edge of the portable electronic appliance while forming a non-zero angle relative to a vertical plane.
